(19) United States
(12) Patent Application Publication
(10) Pub. No.: US 2025/0301977 A1
(43) Pub. Date: Oct. 2, 2025

(54) ALGAL REEF AND METHOD FOR MANUFACTURING SAME

(71) Applicant: Hokkaido Electric Power Company, Incorporated, Hokkaido (JP)

(72) Inventors: Jiro TSUJINO, Hokkaido (JP); Shukichi HASHIDA, Hokkaido (JP); Masatoshi TSUNO, Hokkaido (JP)

(21) Appl. No.: 18/867,354

(22) PCT Filed: Apr. 28, 2023
(86) PCT No.: PCT/JP2023/016941

§ 371 Date: Nov. 19, 2024

(30) Foreign Application Priority Data
May 23, 2022 (JP) 2022-083804

(51) Int. Cl. A01G 33/00

(52) U.S. Cl. CPC A01G 33/00; A01K 61/70

(57) ABSTRACT

An algal reef includes ash powder obtained by burning coal or biomass and a hardening agent that has hardened through a chemical reaction in a state of being mixed with the ash powder. The hardening agent may contain at least one of slaked lime or gypsum hemihydrate. The algal reef may include at least one of granules containing calcium carbonate or gravel as an aggregate. The granules containing calcium carbonate may be produced by the reaction of calcium hydroxide with carbon dioxide in a carbon dioxide absorption facility. In the algal reef, pellets containing the ash powder and the hardening agent may be put into a liquid-permeable bag.

### TECHNICAL FIELD

The present disclosure relates to an algal reef and a method for manufacturing the same.

### BACKGROUND ART

Coal ash discharged from thermal power plants, steel mills, and the like is mainly used as a raw material for cement, but in recent years, as the demand for cement has decreased, other uses are being considered. One example is an attempt to use coal ash for algal reef blocks to prevent a phenomenon called reef burning that causes the death of organisms in coastal waters. Patent Literature 1 discloses algal reef blocks that contain a granular coal ash material as an aggregate and has gaps between the granular coal ash materials.

### CITATION LIST

### Patent Literature

Patent Literature 1: Unexamined Japanese Patent Application Publication No. 2011-229489

### SUMMARY OF INVENTION

### Technical Problem

The algal reef blocks of Patent Literature 1 are produced by manufacturing a granular coal ash material, mixing cement with blast furnace slag, and then mixing the thus obtained blast furnace cement with the granular coal ash material. Accordingly, such algal reef blocks of Patent Literature 1 are problematic in that these algal reef blocks require high manufacturing cost, and thus are unsuitable for mass production. Such a problem also exists when biomass combustion ash is used instead of coal ash.

The present disclosure has been made based on this background, and the objective is to provide an algal reef that can be manufactured at low cost using ash obtained by burning coal or biomass, and a method for manufacturing the same.

### Solution to Problem

In order to achieve the above objective, the algal reef according to the present disclosure includes ash powder obtained by burning coal or biomass, and a hardening agent that hardens through a chemical reaction in a state of being mixed with the ash powder.

### Advantageous Effects of Invention

According to the present disclosure, the algal reef that can be manufactured at low cost using ash obtained by burning coal or biomass and the method for manufacturing the same can be provided.

### BRIEF DESCRIPTION OF DRAWINGS

FIG. 1 illustrates how algal reefs according to the embodiments of the present disclosure are placed on the seabed;

FIG. 2 is a flowchart illustrating the flow of a method for manufacturing pellets according to the embodiments of the present disclosure;

FIG. 3 is a flowchart illustrating the flow of the method for using the algal reefs according to the embodiments of the present disclosure;

FIG. 4 is a table illustrating the composition and the manufacturing method of each substrate in Example ;:

FIG. 5 is a table of photographs illustrating the appearance of Rishiri kelp (Laminaria ochotensis Miyabe) sporophytes attached to the surface of each substrate in filtered seawater in Example 1;

FIG. 6 is a table of photographs illustrating the appearance of Rishiri kelp sporophytes attached to the surface of each substrate in a PES-modified medium in Example 1;

FIG. 7 is a table illustrating the number of Rishiri kelp sporophytes per unit area attached to the surface of each substrate in Example 1;

FIG. 8A is a photograph illustrating how one of the substrates in Example 1 is anchored to a rope;

FIG. 8B is a photograph illustrating how the substrates of FIG. 8A are moored in the sea;

FIG. 9 is a table of photographs illustrating the appearance of dulse irideae (Mazzaella japonicua (Mikami) Hommersand), Ogonori (Gracilaria vermiculophylla), and laver species (Pyropia) attached to the surface of each substrate in Example 2; and

FIG. 10 is a table illustrating the number of dulse irideae and Ogonori individuals attached to the surface of each substrate in Example 2, as well as the coverage by laver.

### DESCRIPTION OF EMBODIMENTS

Below, an algal reef and a method for manufacturing the same according to the embodiments of the present disclosure are described in detail with reference to the drawings. In each drawing, identical or equivalent parts are marked with the same symbol.

The algal reef is a facility that allows algae to attach to a surface in order to propagate algae in water. The algal reef is placed in any underwater location where you want to propagate algae, such as in oceans, rivers, lakes, ponds, and swamps. The algal reef is preferably placed in water with algae seedlings attached to the surface. Algae to be attached to the algal reef may be any algae that can absorb carbon dioxide (CO₂) in water through photosynthesis. For example, brown algae such as kelp, Wakame seaweed, Hijiki seaweed and Mozuku seaweed, and red algae such as dulse irideae (Mazzaella japonicua (Mikami) Hommersand), Ogonori (Gracilaria vermiculophylla), laver (Pyropia) and Tengusa seaweed (any red alga in the family Gelidiaceae) are preferred.

Preferred examples of brown algae to be attached to the algal reef include seaweed of the order Laminariales, especially those of the family Laminariaceae, such as Makombu (Saccharina japonica), Onikombu (Saccharina diabolica), Risiri kelp (Laminaria ochotensis Miyabe), Hosome kelp (Laminaria religiosa), Mitsuishi kelp (Laminaria angustata Kjellman), Naga kelp (Laminaria longissima), Nekoashi kelp (Arthrothamnus bifidus), and Gagome Kelp (Saccharina sculpela). In all cases of seaweed members of the family Laminariaceae, spores called zoospores that can swim in the sea attach to rocks and algal reefs. Zoospores having stuck thereto then become male or female gametophytes to release sperms or eggs, and the sperms fertilize the eggs for growth so as to form visually observable sporophytes. Below, a case in which algal reefs are placed on the seabed to grow seaweed is described as an example.

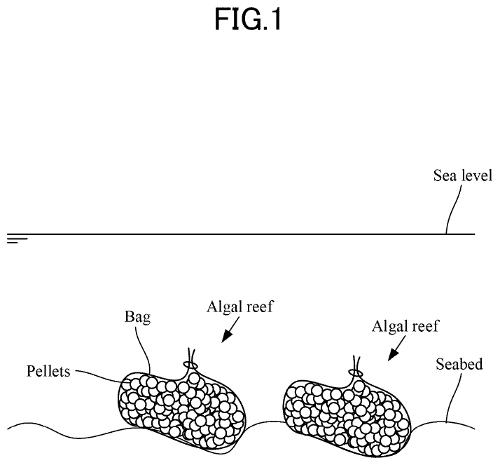

As illustrated in FIG. 1, each algal reef includes pellets produced by shaping kneaded materials using a press device, followed by hardening, and a liquid-permeable bag that can be packed with multiple pellets. The pellets may be of any shape, but are cylindrical granules, for example, the diameter and length of which range from preferably 5 mm to 20 mm, respectively.

The bag has openings through which algae attached to the pellets can extend outward, and is made of wire mesh, for example. The bag is provided with an opening portion through which the pellets are fed, and the opening portion is sealed by a cord-like member, such as a rope, before the bag is placed in the sea. The algal reef formed of a bag containing multiple pellets is easier for placement on site than a block-shaped algal reef and can be adjusted in size and shape for easier handling.

Next, the components contained in the pellets are described. The pellets are hardened in a state where the main component, coal ash, is mixed with a hardening agent. The hardening agent is a material that hardens through a chemical reaction in a state of containing coal ash. The hardening agent agglomerates coal ash and an aggregate into a cohesive mass as it hardens itself. The hardening agent is preferably uniformly dispersed with respect to the main component, coal ash.

Coal ash is ash powder obtained by coal combustion, is mainly composed of silica (SiO₂) or alumina (Al₂O₃), and is mainly discharged from coal-fired power plants and steel mills. The weight percent of coal ash in the pellets ranges from, for example, 60% to 90%, preferably from 70% to 80% by weight. Coal ash is, for example, fly ash. Fly ash is composed of fine spherical particles of ash generated by coal combustion, suspended with combustion gases, and then collected in a dust collector.

Coal ash may be the powder of a desulfurizing agent to which nitrogen oxide in the exhaust gas generated by coal combustion is adsorbed. The desulfurizing agent is prepared by mixing coal ash and gypsum, and then shaping the mixture into pellets, containing large amounts of coal ash. In addition to coal ash and gypsum, the desulfurizing agent, to which nitrogen oxide is adsorbed, contains calcium oxide, silicate, and a trace amount of nitrogen.

The hardening agent is, for example, slaked lime or gypsum hemihydrate powder, wherein either or both slaked lime and gypsum hemihydrate may be mixed. The slaked lime is mainly composed of calcium hydroxide, and has the property of hardening in air. The weight percent of slaked lime in the pellets, for example, ranges from 5% to 20%, preferably from 8% to 14%. Gypsum hemihydrate (calcined gypsum) is a mineral mainly composed of calcium sulfate (CaSO₄), and has the property of reacting with water to form dihydrate gypsum and hardening. The weight percent of gypsum in the pellets, for example, ranges from 1% to 10%, preferably from 2% to 6%.

The pellets may contain an aggregate other than coal ash and the hardening agent. The aggregate is a skeletal material of the algal reef, and examples thereof include granules containing calcium carbonate and gravel. The pellets may be composed of a single type of material or may contain multiple types of material.

Examples of granules containing calcium carbonate include crushed shells and limestone granules. Examples of shells include scallops, Akoya pearl oysters, and oysters, the main component of which is calcium carbonate (CaCO₃). Limestone is a mineral composed mainly of calcium carbonate. Granules containing calcium carbonate may contain calcium carbonate discharged after carbon dioxide absorption in a carbon dioxide absorption facility. Calcium carbonate discharged from carbon dioxide absorption facilities is installed in the exhaust systems of thermal power plants and other facilities, where calcium hydroxide (Ca(OH)₂) is produced by reacting with carbon dioxide in the exhaust gas. The weight percent of the aggregate in the pellets ranges from, for example, 5% to 30%, preferably from 10% to 20%.

Binders and, if necessary, water may be added to the pellets. Binders are materials that agglomerate coal ash and aggregates, such as clay, cement, soda ash, or organic compounds such as alginic acid and polyvinyl alcohol. The weight percent of the binder in the pellets ranges from, for example, 10% to 30%, preferably from 15% to 25%. The amount of water to be added during pellet shaping may be set appropriately considering the ease of shaping and pellet strength.

The pellets may be mixed with materials containing algal nutritive salts, such as chicken droppings combustion ash. Nutritive salts are salts necessary for algal growth, and examples thereof include phosphates, nitrates, nitrites, ammonium salts, and silicates. Chicken droppings combustion ash is ash obtained from the combustion of chicken droppings and contains nutritive salts such as phosphate and potassium.

Since the algal reef according to the embodiments includes pellets having the above technical features, kelp and other seaweed members can be attached to the surface for them to efficiently absorb carbon dioxide in the water. In addition, compared to conventional concrete algal reefs, the algal reef can also promote the growth of seaweed, making it suitable as a countermeasure against reef burning in coastal waters.

The technical features of the algal reef and the pellets are as described above.

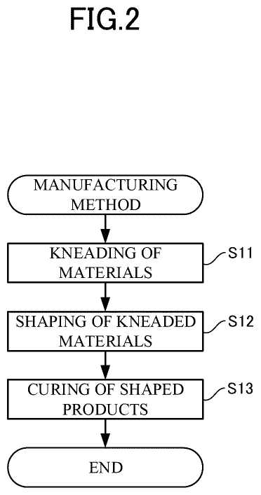

Next, referring to FIG. 2, the flow of the manufacturing method of pellets constituting the algal reef according to the embodiments is described. First, materials including coal ash and the hardening agent are kneaded using a kneader (Step S11). If the materials include water, the other materials except water are first kneaded without water, and then water is added to the kneaded materials for further kneading.

Next, the materials kneaded in step S11 are shaped into pellets (step S12). The shaping step may be any method, for example, extrusion using an extrusion machine. In extrusion, the kneaded materials are passed through a number of holes produced in a plate and cut to a certain length by a cutter, so as to shape cylindrical-shaped granules.

Next, the shaped pellets shaped in step S12 are cured for hardening (step S13). In the curing step, for example, an appropriate technique can be selected from among underwater curing, steam curing, and sintering, and then performed. In underwater curing, pellets are submerged in water for curing to improve pellet strength, while in steam curing, pellets are exposed to hot steam to improve pellet strength faster than in underwater curing. In sintering, for example, the pellets are sintered at a high temperature of about 1,000° C.

The above is the flow of the method for manufacturing the pellets.

### Instructions for Use

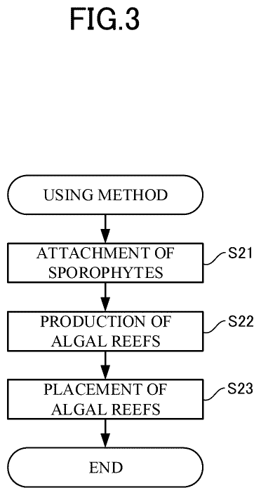

Next, referring to FIG. 3, the flow of the method for using the algal reef according to the embodiments is described. First, algae seedlings, such as kelp sporophytes, are attached to a surface of the pellets and allowed to grow to a certain size in a water tank filled with seawater (step S21).

Next, the algal reef with algae seedlings attached to the surface is produced by putting multiple pellets in/on which algae seedlings have rooted in step S21 into a net-like bag through which water can pass (step S22). The amount of pellets to be put into the bag may be determined according to the shape of the seabed and the strength of the current. The step of putting the pellets into the bag may be conducted in a facility where the algae seedlings are attached or near the site where the algal reef is placed.

Next, the algal reef produced in step S22 is placed in water (step S23). At this time, it is advisable to, for example, fix the algal reef to the seabed with the use of an anchor or the like, if necessary.

The above is the flow of the method for using the algal reef.

As described above, the algal reef according to the embodiments includes ash powder obtained by burning coal and the hardening agent that has hardened through a chemical reaction in a state of being mixed with the ash powder. Therefore, the algal reef can be manufactured with a simple procedure utilizing coal ash discharged from coal combustion, and thus can be manufactured at low cost.

Further, the algal reef according to the embodiments enables the attachment of kelp, which is capable of absorbing a large amount of carbon dioxide in water and forming a vast algal bed, to the surface of the algal reef, and thus can reduce carbon dioxide emissions in electric power industries, and the like. Compared to concrete algal reefs, the algal reef according to the embodiments promotes the growth of various types of seaweed, so as to be also suitable against the reef burning phenomenon in coastal waters.

The algal reef according to the embodiments may include calcium carbonate, which is discharged after carbon dioxide absorption in a carbon dioxide absorption facility, as an aggregate. The reuse of emissions from such carbon dioxide absorption facilities in the algal reef can further contribute to the reduction of the amount of carbon dioxide emissions in electric power industries, and the like.

The present disclosure is not limited to the above embodiments and can be modified as described below.

### Examples of Variations

In the above embodiments, coal ash obtained by burning coal is used as the main raw material, but the present disclosure is not limited thereto. The powder of biomass fuel ash obtained by burning biomass may also be used. Examples of biomass include woody materials, livestock droppings, sewage sludges, and agricultural residues.

In the above embodiments, the algal reef is produced by putting a large number of pellets into a wire mesh, but the present disclosure is not limited thereto. For example, a block with the same or equivalent composition as that of the pellets may also be an algal reef. The shape of the block may be any shape and may be cubic, or tetrapod block shaped (tetrapod shape), for example.

In the above embodiments, the pellets are manufactured using extrusion, but the present disclosure is not limited thereto. For example, the pellets may be manufactured using methods other than extrusion, such as press forming, rolling granulation, or agitated granulation.

In the above embodiments, the algal reef is placed in water with algae seedlings attached to the surface of the algal reef, but the present disclosure is not limited thereto. In waters where algal growth is vigorous, the algal reef may be placed in water without attaching algae seedlings to the surface of the algal reef.

In the above embodiments, the algal reef is placed in water in a natural environment, but the present disclosure is not limited thereto. For example, carbon dioxide may be absorbed into the water using a gas dissolving device, and then the algal reef may be placed in water with the increased concentration of carbon dioxide in water, allowing the carbon dioxide to be absorbed by the algae and further promoting algal growth.

The above embodiments are examples, and the present disclosure is not limited to them. Various embodiments are possible without departing from the intent of the invention as described in claims. The components described in the embodiments and variations can be freely combined. Inventions that are equivalent to the claimed invention are also included in the present disclosure.

The present disclosure is described in detail below with Examples. However, the present disclosure is not limited to these Examples.

### Example 1

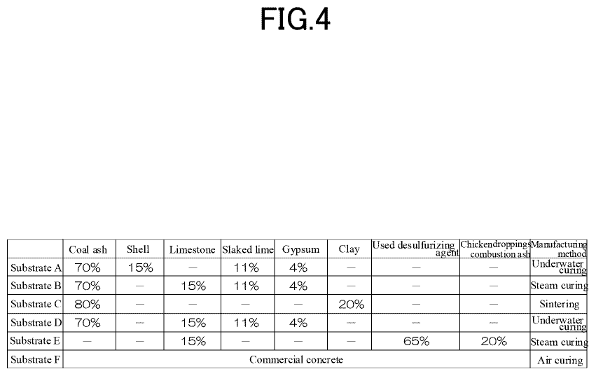

In Example 1, block-shaped substrates A to E mainly composed of coal ash were produced, and subjected to a test for culturing Rishiri kelp attached to substrates A to E. Substrates A to E have compositions listed in FIG. 4, respectively, and were manufactured by underwater curing, steam curing, or sintering after kneading raw materials. In underwater curing, for example, the substrates were stored for two weeks at a temperature of 20° C. and 90% humidity, and then submerged in water at a temperature of 20° C. and stored for two weeks. In steam curing, the substrates were sealed in plastic bags immediately after shaping and then stored for 24 to 48 hours while being exposed to steam at a temperature of 90° C.

Substrates A to E were then immersed two at a time in the solution of Rishiri kelp zoospores for the zoospores to attach to the surface. The solution of zoospores was prepared by the following procedure. First, sections of the sorus forming part were cut from the collected Rishiri kelp sporophytes, filtered through a cartridge filter, and then washed with filtered seawater. Filtered seawater is seawater treated at a temperature of 121° C. for 15 minutes. Next, the surfaces of the sections were wiped off using paper towels, wrapped in paper towels, sealed in plastic bags, and then stored overnight in a cool, dark place. On the next day, the sections were immersed in filtered seawater to release zoospores. The number of zoospores was then adjusted to reach 5,000/L.

Each of substrates A to F was then placed one by one in 1 L of filtered seawater and provasoli enriched seawater (PES) modified medium for culturing and cultured for 5 weeks under a water temperature of 10° C., an illuminance of 5,000 Lux, and a photoperiod of 12L:12D (12-hour light period, 12-hour dark period). The PES modified medium is a nutrient-enriched medium prepared based on seawater for promoting seaweed growth. Observations of the cultured individuals were made every week during the culture period to observe the number of sporophytes attached and changes in the substrate surface. During the first two weeks of culture, 1 mg of germanium oxide was added to the culture solution to inhibit the growth of diatoms. A portion of the culture solution was collected at each observation, and the concentrations of nitrogen and phosphorus, which are nutritive salts essential for seaweed growth, were measured using an autoanalyzer (BL TEC K. K.). For comparison, a similar experiment was conducted on substrate F produced with commercial concrete.

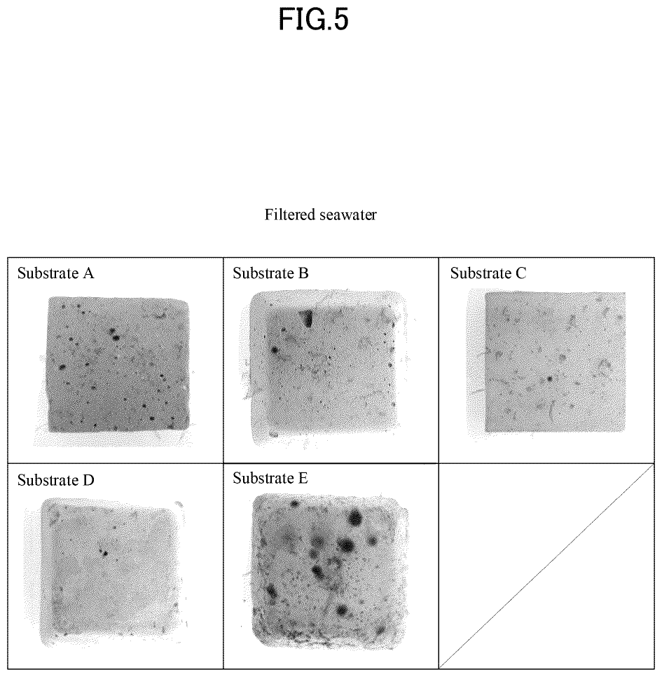

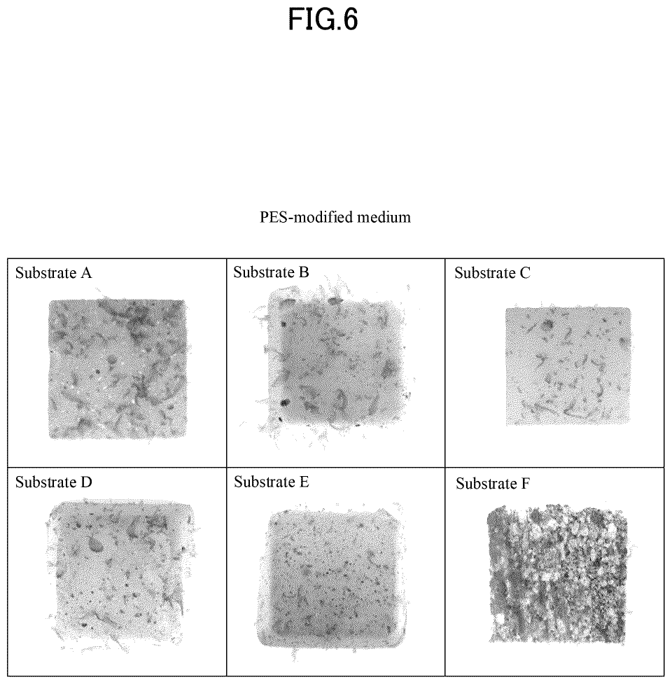

FIGS. 5 and 6 are photographs of the appearance of the sporophytes of Rishiri kelp at week 5 of culture in filtered seawater and PES modified medium, respectively. In all cases of using these culture solutions, Rishiri kelp sporophytes were confirmed to grow on the surface of each of substrates A to E. In all cases of using these culture solutions, the sporophytes of sizes observable to the naked eye appeared on the surface of each of substrates A to E at week 3 and week 4 of culture.

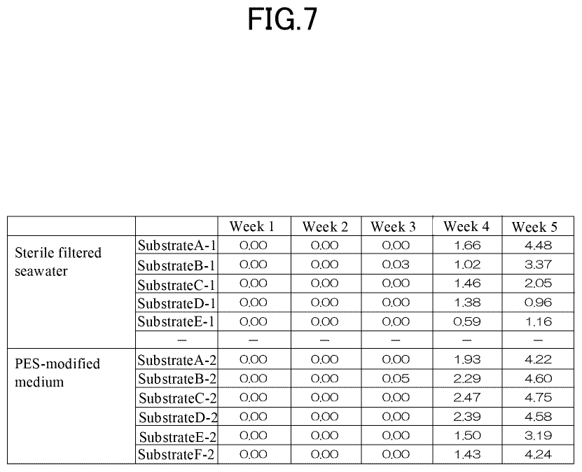

As illustrated in FIG. 7, when cultured in filtered seawater, the number of attached sporophytes per unit area at week 5 of culture was about 4.5 sporophytes/cm² for substrate A and about 3.4 sporophytes/cm² for substrate B. Other substrates tended to have fewer numbers of attached sporophytes than those on substrates A and B. When cultured in a PES-modified medium, the number of attached sporophytes per unit area at week 5 of culture was about 4 sporophytes/cm², except for substrate E.

No morphological abnormalities such as shrinkage or twisting were observed in/on the leafy parts of the sporophytes in all cases of using these culture solutions and substrates A to E. The growth on substrate B was faster than that on the other substrates, and the cultured individuals tended to be larger in size. This may be because the 20 concentration of PO₄—P (phosphoric phosphorus) in the culture solution remained high for substrate B. High concentrations of NO₃—NO₂—N (nitric and nitrous nitrogen) and PO₄—P were detected in the culture solutions of the test plot where substrate E had been used. Contrary to expectations, the growth of the sporophytes was poor, and some of their leafy parts were fading. This may be because the excess nitrogen and phosphorus supplied by substrate E inhibited the growth of the sporophytes. Note that diatoms grew significantly in the case of substrate E despite the addition of germanium oxide.

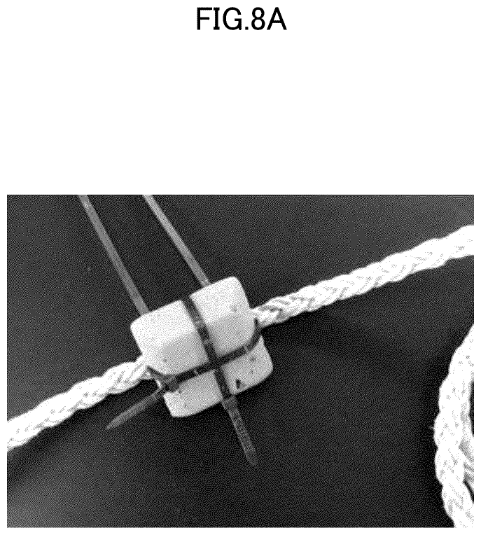

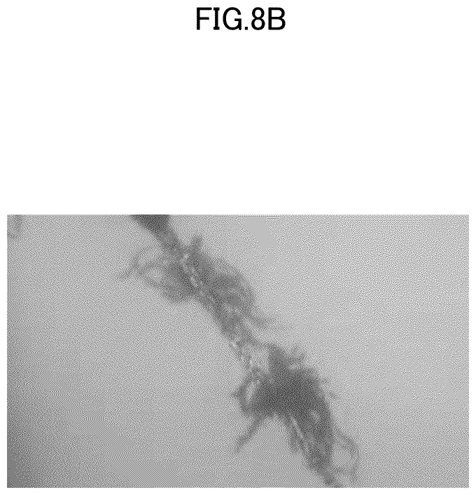

To investigate growth conditions in a real environment, substrates with Risiri kelp sporophytes attached thereto were anchored to a rope and placed in/on an incubation net in a fishing port, as illustrated in FIG. 8A. One month after placement, observation with an underwater camera confirmed that the substrates remained uncollapsed and the sporophytes also grew, as illustrated in FIG. 8B.

### Example 2

In Example 2, whether seaweed other than Laminariales can grow on substrates A to C mainly composed of coal ash was examined. Dulse irideae (Mazzaella japonicua (Mikami) Hommersand), laver (Pyropia), and Ogonori (Gracilaria vermiculophylla) that inhabit in the seas around Hokkaido were attached to substrates A to C mainly composed of coal ash and then subjected to a culture test according to the same procedure as in Example 1.

First, 150 tetraspores each of dulse irideae and Ogonori immersed in 2 L of seawater and 2 mg of laver filaments were sprinkled over the surface of each of substrates A to C and allowed to stand for 2 weeks for culturing. Dulse irideae and Ogonori tetraspores and laver filaments were obtained by the following procedure. First, the collected female dulse irideae gametophytes and the collected female Ogonori gametophytes, and laver gametophytes were washed with filtered seawater. Next, the cystocarp-forming parts of dulse irideae and Ogonori, as well as the zygosporangium-forming parts of laver were each cut out, and then each section was immersed in filtered seawater. The released carpospores and zygospores were then collected and cultured for about 5 to 7 months, respectively, to obtain dulse irideae and Ogonori tetrasporophytes, and laver filaments. The tetrasporangium-forming parts were cut out from dulse irideae and Ogonori tetrasporophytes, and then immersed in filtered seawater to obtain tetraspores. laver filaments were well shredded using a sterile scalpel.

Next, each of substrates A to C, to which dulse irideae and Ogonori tetraspores or laver filaments were attached, was transferred into 1 L of PES-modified medium and cultured for 8 weeks at a water temperature of 10° C. for dulse irideae and 20° C. for Ogonori and laver. Both were cultured under an illuminance of 5,000 Lux and a photoperiod of 12L:12D. Cultured individuals were observed every week during the culture period, and the number of germinating individuals was counted for dulse irideae and Ogonori. For laver, the coverage over the substrate surface was calculated at and after week 4 of culture when improvement in filamentous growth and coloration began to be observed. Note that the “coverage” refers to the percentage of the surface area covered by a particular species in a plant community.

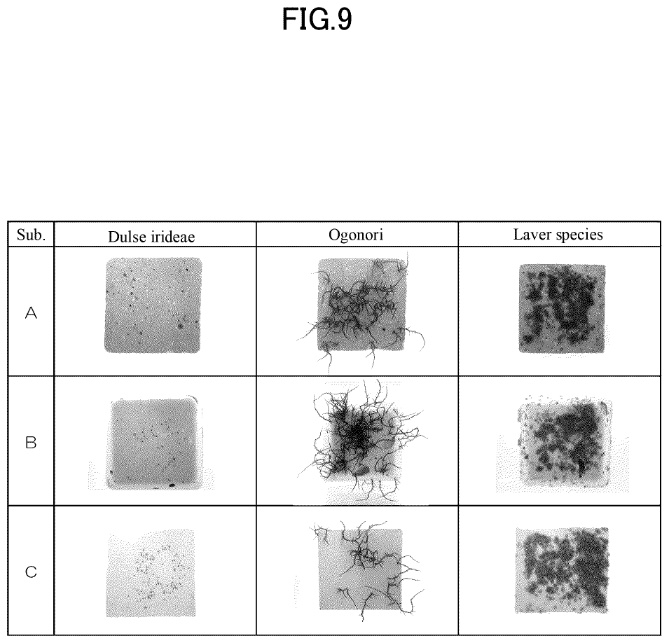

FIG. 9 illustrates the photographs of the appearance of dulse irideae and Ogonori tetraspores and laver filaments at week 5 of culture. As illustrated in FIG. 9, the growth of dulse irideae and Ogonori tetraspores and laver filaments was confirmed on the surface of each of substrates A to C.

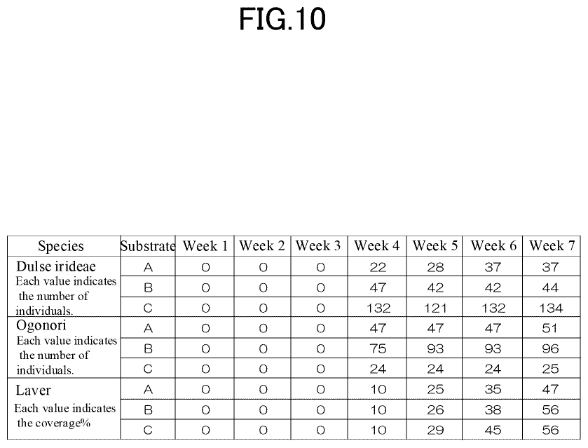

For dulse irideae and Ogonori, individuals of sizes observable to the naked eye appeared on each of substrates A to C at week 4 of culture. As illustrated in FIG. 10, at the end of the culture test, the largest number of dulse irideae individuals were attached to substrate C, and the largest number of Ogonori individuals were attached to substrate B. No morphological abnormalities were observed in dulse irideae and Ogonori on each of substrates A through C. When culturing of Ogonori was continued for a period of about 2 to 3 weeks after the end of the culture test, the maturation of male and female gametophytes was confirmed, as well as the formation of cystocarps could be observed. There was no significant difference in the coverage by laver filaments among substrates A to C, and no abnormalities in the tissue of laver filaments were observed under the optical microscope.

This application claims the benefit of Japanese Patent Application No. 2022-83804 filed on May 23, 2022, the entire disclosure of which is incorporated by reference herein.

### Industrial Applicability

The algal reef and the method for manufacturing the same according to the present disclosure are useful because the algal reef can be manufactured at low cost using ash obtained by burning coal or biomass.

1. An algal reef, comprising:
ash powder obtained by burning coal or biomass; and
a hardening agent that has hardened through a chemical reaction in a state of being mixed with the ash powder.

2. The algal reef according to claim 1, wherein the hardening agent comprises at least one of slaked lime or gypsum hemihydrate.

3. The algal reef according to claim 1, comprising at least one of a granule containing calcium carbonate or gravel as an aggregate.

4. The algal reef according to claim 3, wherein the granule containing calcium carbonate is produced by the reaction of calcium hydroxide with carbon dioxide in a carbon dioxide absorption facility.

5. The algal reef according to claim 1, wherein a pellet comprising the ash powder and the hardening agent is put into a liquid-permeable bag.

6. The algal reef according to claim 5, wherein an algae seedling cultured in filtered seawater or a medium is attached in advance to a surface of the pellet.

7. A method for manufacturing an algal reef, comprising:
kneading ash powder obtained by burning coal or biomass and a hardening agent that hardens through a chemical reaction in a state of being mixed with the ash powder,
shaping the kneaded materials, and
hardening the shaped material.
